(19) United States
(12) Patent Application Publication
(10) Pub. No.: US 2026/0362015 A1
(43) Pub. Date: Nov. 12, 2026

(54) IMAGE GENERATION METHOD AND APPARATUS, DEVICE, STORAGE MEDIUM, AND PROGRAM PRODUCT

(71) Applicant: Glenfly Tech Co., Ltd., Shanghai (CN)

(72) Inventors: Feifei YANG, Shanghai (CN); Xiaolong WU, Shanghai (CN)

(21) Appl. No.: 19/669,585

(22) Filed: May 6, 2026

(30) Foreign Application Priority Data
May 7, 2025 (CN) 202510587876.9

(51) Int. Cl. H04N 23/741; H04N 23/73

(52) U.S. Cl. CPC H04N 23/741; H04N 23/73

(57) ABSTRACT

Image generation method and apparatus, a device, a storage medium, and a program product are provided. The method includes: obtaining image statistical information of a previous HDR frame; generating a weighted histogram of the previous HDR frame based on the image statistical information of the previous HDR frame, the weighted histogram being configured for describing effective scene information of the previous HDR frame; calculating long and short exposure parameters of a current HDR frame based on the weighted histogram of the previous HDR frame; and obtaining the current HDR frame based on the long and short exposure parameters of the current HDR frame. The method can improve the generation quality of HDR images.

### CROSS-REFERENCE TO RELATED APPLICATION

This application claims priority to Chinese Patent Application No. 202510587876.9, filed with CNIPA on May 7, 2025, entitled as “IMAGE GENERATION METHOD AND APPARATUS, DEVICE, STORAGE MEDIUM, AND PROGRAM PRODUCT”, the entire contents of which are incorporated herein by reference.

### TECHNICAL FIELD

This application relates to the technical field of image processing, and in particular, to an image generation method, an image generation apparatus, a device, a storage medium, and a program product.

### BACKGROUND

The natural scene has an extremely wide dynamic range, whereas a dynamic range shot by a widely used imaging device under a single exposure parameter is limited, which is far smaller than the dynamic range of the natural scene. Therefore, an image sequence obtained by multiple times of shooting and imaging by the imaging device using different exposure parameters under the same scene can be fused through multi-exposure image fusion, so as to obtain a high dynamic range (HDR) image with rich contents, reflecting all contents of the natural scene as much as possible.

In the related art, an image sensor supporting digital overlap (DOL) technique may be adopted to achieve “quasi-simultaneous” acquisition of a multi-exposure image sequence, which effectively solves the ghost problem existed in conventional multi-exposure HDR imaging technique based on frame acquisition. As a result, the multi-exposure HDR imaging has been widely used in the industry.

Prior to acquiring the multi-exposure image sequence using the DOL technique, exposure parameters of the imaging device need to be estimated. The exposure parameters of the imaging device may be estimated by solving an optimal exposure parameter set to cover a full luminance range of the scene, or by maximizing the signal-to-noise ratio of the HDR image. These two estimation manners are highly sensitive to scene variation, so the estimated exposure parameters are not accurate enough in scenarios with significant scene variation, resulting in poor quality of the generated HDR images.

### SUMMARY

In view of the above-mentioned technical issues, it is necessary to provide an image generation method, an image generation apparatus, a device, a storage medium, and a program product that can improve the quality of HDR image generation

According to a first aspect, the present disclosure provides an image generation method, including:
obtaining image statistical information of a previous high-dynamic-range (HDR) frame;
generating a weighted histogram of the previous HDR frame based on the image statistical information of the previous HDR frame, the weighted histogram being configured for describing effective scene information of the previous HDR frame;
calculating long and short exposure parameters of a current HDR frame based on the weighted histogram of the previous HDR frame; and
obtaining the current HDR frame based on the long and short exposure parameters of the current HDR frame.

In an embodiment, the image statistical information includes an exposure parameter and statistical luminance information. Generating the weighted histogram of the previous HDR frame based on the image statistical information of the previous HDR frame includes:
taking a lightest image block in the previous HDR frame as a photometry target and conducting photometric measurement on the lightest image block based on the exposure parameter of the previous HDR frame, to obtain scene photometric data of the lightest image block;
performing weighting processing on the statistical luminance information of a center region of the previous HDR frame based on the scene photometric data of the lightest image block, to obtain a weighted region luminance of the center region;
dividing a luminance range of the previous HDR frame into multiple luminance intervals based on the weighted region luminance of the center region;
calculating respective weighting parameters for curve segments in a histogram weighting curve that correspond to the multiple luminance intervals; and
generating the weighted histogram of the previous HDR frame based on the weighting parameters of the curve segments corresponding to the multiple luminance intervals in the histogram weighting curve.

In an embodiment, the performing weighting processing on the statistical luminance information of the center region of the previous HDR frame based on the scene photometric data of the lightest image block, to obtain the weighted region luminance of the center region includes:
determining a luminance weight parameter of the center region of the previous HDR frame based on the scene photometric data of the lightest image block; and
weighting a maximum luminance of the center region, a minimum luminance of the center region, and an average luminance of the center region in the statistical luminance information according to the luminance weight parameter of the center region of the previous HDR frame, to obtain the weighted region luminance of the center region.

In an embodiment, calculating the respective weighting parameters for the curve segments in the histogram weighting curve that correspond to the multiple luminance intervals includes:
determining an illumination-prior center non-saliency probability of the previous HDR frame based on the scene photometric data of the lightest image block;
determining spatial-luminance center distribution probability of the previous HDR frame based on the weighted region luminance of the center region; and
determining the weighting parameters of the curve segments corresponding to the multiple luminance intervals in the histogram weighting curve based on the illumination-prior center non-saliency probability and the spatial-luminance center distribution probability.

In an embodiment, determining the illumination-prior center non-saliency probability of the previous HDR frame based on the scene photometric data of the lightest image block includes:
determining, based on the scene photometric data of the lightest image block, a target scene type corresponding to the previous HDR frame and a condition for filtering block(s) of interest corresponding to the target scene type;
determining a quantity of block(s) of interest in a pericentral region in the previous HDR frame based on the condition for filtering block(s) of interest; and
quantifying the quantity of block(s) of interest in the pericentral region in the previous HDR frame into the illumination-prior center non-saliency probability distribution probability of the previous HDR frame.

In an embodiment, the determining the spatial-luminance center distribution probability of the previous HDR frame based on the weighted region luminance of the center region includes:
determining quantities of light blocks and dark blocks in the pericentral region in the previous HDR frame based on the weighted region luminance of the center region;
determining a proportion and a spatial symmetry parameter of the light blocks in the pericentral region and a proportion and a spatial symmetry parameter of the dark blocks in the pericentral region based on the quantities of the light blocks and the dark blocks in the pericentral region;
determining a light center distribution probability and a dark center distribution probability based on the proportions and the spatial symmetry parameters of the light blocks and the dark blocks in the pericentral region; and
determining the spatial-luminance center distribution probability of the previous HDR frame based on the light center distribution probability and the dark center distribution probability.

In an embodiment, calculating the long and short exposure parameters of the current HDR frame based on the weighted histogram of the previous HDR frame includes:
obtaining the noise threshold and the saturation threshold of the camera component;
determining a ratio of a short exposure gain value to a long exposure gain value of the current HDR frame based on the weighted histogram of the previous HDR frame, the noise threshold, and the saturation threshold; and
if the ratio of the short exposure gain value to the long exposure gain value is less than or equal to a maximum gain ratio of the camera component, taking the initial exposure parameters of the current HDR frame correspond to the weighted histogram of the previous HDR frame as the long and short exposure parameters of the current HDR frame.

In an embodiment, after determining the ratio of the short exposure gain value to the long exposure gain value of the current HDR frame, the image generation method further includes:
if the ratio of the short exposure gain value to the long exposure gain value is greater than the maximum gain ratio of the camera component, solving the exposure optimization equation of the weighted histogram according to an exposure gain limitation to obtain the long and short exposure parameters of the current HDR frame;
where the exposure gain limitation is that the ratio of the short exposure gain value to the long exposure gain value is equal to the maximum gain ratio, and an optimization objective of the exposure optimization equation is to minimize the proportion of the weighted histogram falling outside a target region, the target region being a region bounded by the noise threshold and the saturation threshold.

In an embodiment, obtaining the current HDR frame based on the long and short exposure parameters of the current HDR frame includes:
capturing a current frame of interleaved exposure low-dynamic-range (LDR) image based on the long and short exposure parameters of the current HDR frame; and
synthesizing the current frame of interleaved exposure LDR image to obtain the current HDR frame.

According to a second aspect, the present disclosure further provides an image generation apparatus, including:
an acquisition module, configured to obtain image statistical information of a previous high-dynamic-range (HDR) frame;
an exposure parameter calculation module, configured to generate a weighted histogram of the previous HDR frame based on the image statistical information of the previous HDR frame, the weighted histogram being configured to describe effective scene information of the previous HDR frame; and calculate long and short exposure parameters of the current HDR frame based on the weighted histogram of the previous HDR frame; and
an image generation module, configured to obtain the current HDR frame based on the long and short exposure parameters of the current HDR frame.

In an embodiment, the image statistical information includes an exposure parameter and statistical luminance information. The exposure parameter calculation module is further configured to: select the lightest image block in the previous HDR frame as a photometry target and conduct photometric measurement the lightest image block based on the exposure parameter of the previous HDR frame to obtain scene photometric data of the lightest image block; perform weighting processing on the statistical luminance information of a center region of the previous HDR frame based on the scene photometric data of the lightest image block to obtain weighted region luminance of the center region; divide the luminance range of the previous HDR frame into multiple luminance intervals based on the weighted region luminance of the center region; calculate respective weighting parameters for curve segments in a histogram weighting curve that correspond to the multiple luminance intervals; and generate the weighted histogram of the previous HDR frame based on the weighting parameters of the curve segments corresponding to the multiple luminance intervals in the histogram weighting curve.

In an embodiment, the exposure parameter calculation module is further configured to: determine a luminance weight parameter of the center region of the previous HDR frame based on the scene photometric data of the lightest image block; and perform weighting processing on the maximum luminance of the center region, the minimum luminance of the center region, and the average luminance of the center region in the statistical luminance information according to the luminance weight parameter of the center region of the previous HDR frame, to obtain the weighted region luminance of the center region.

In an embodiment, the exposure parameter calculation module is further configured to: determine a illumination-prior center non-saliency probability of the previous HDR frame based on the scene photometric data of the lightest image block; determine a spatial-luminance center distribution probability of the previous HDR frame based on the weighted region luminance of the center region; and determine the weighting parameters of the curve segments corresponding to the multiple luminance intervals in the histogram weighting curve based on the illumination-prior center non-saliency probability and the spatial-luminance center distribution probability.

In an embodiment, the exposure parameter calculation module is further configured to: determine, based on the scene photometric data of the lightest image block, a target scene type corresponding to the previous HDR frame and a condition for filtering block(s) of interest corresponding to the target scene type; determine, based on the condition for filtering block(s) of interest, the quantity of block(s) of interest in pericentral region in the previous HDR frame; and quantify the quantity of block(s) of interest in the pericentral region in the previous HDR frame into the illumination-prior center non-saliency probability of the previous HDR frame.

In an embodiment, the exposure parameter calculation module is further configured to: determine quantities of light and dark blocks in the pericentral region in the previous HDR frame based on the weighted region luminance of the center region; determine a proportion and a spatial symmetry parameter of the light blocks in the pericentral region and a proportion and a spatial symmetry parameter of the dark blocks in the pericentral region based on the quantities of the light and dark blocks in the pericentral region; determine a bright center distribution probability and a dark center distribution probability based on the proportions and the spatial symmetry parameters of the light blocks and the dark blocks in the pericentral region; and determine the spatial-luminance center distribution probability of the previous HDR frame based on the bright center distribution probability and the dark center distribution probability.

In an embodiment, the exposure parameter calculation module is further configured to: obtain the noise threshold and the saturation threshold of a camera component; determine the ratio of the short exposure gain value to a long exposure gain value of the current HDR frame based on the weighted histogram of the previous HDR frame, the noise threshold, and the saturation threshold; and perform the following operation if the ratio of the short exposure gain value to the long exposure gain value is less than or equal to the maximum gain ratio of the camera component: take the initial exposure parameters of the current HDR frame corresponding to the weighted histogram of the previous HDR frame as the long and short exposure parameters of the current HDR frame.

In an embodiment, the exposure parameter calculation module is further configured to: perform the following operation if the ratio of the short exposure gain value to the long exposure gain value is greater than the maximum gain ratio of the camera component: solve an exposure optimization equation of the weighted histogram according to an exposure gain limitation to obtain the long and short exposure parameters of the current HDR frame.

The exposure gain limitation is that the ratio of the short exposure gain value to the long exposure gain value is equal to the maximum gain ratio. An optimization objective of the exposure optimization equation is to minimize the proportion of the weighted histogram outside the target region and the target region is a region bounded by the noise threshold and the saturation threshold.

In an embodiment, the image generation module is further configured to: capture a current frame of interleaved-exposure LDR image based on the long and short exposure parameters of the current HDR frame; and synthesize the current frame of interleaved-exposure LDR image to obtain the current HDR image.

According to a third aspect, the present disclosure further provides a computer device, including a memory and a processor. The memory stores a computer program. The processor, when executing the computer program, performs the image generation method in the first aspect.

According to a fourth aspect, the present disclosure further provides a non-transitory computer-readable storage medium, storing a computer program. When the computer program is executed by a processor, the processor is caused to perform the image generation method in the first aspect.

According to a fifth aspect, the present disclosure further provides a computer program product, including a computer program. When the computer program is executed by a processor, the processor is caused to perform the image generation method in the first aspect.

According to the above-described image generation method, image generation apparatus, device, storage medium and program product, firstly, image statistical information of a previous HDR frame is obtained; secondly, a weighted histogram of the previous HDR frame is generated based on the image statistical information of the previous HDR frame, the weighted histogram being configured for describing effective scene information of the previous HDR frame; thirdly, long and short exposure parameters of a current HDR frame are calculated based on the weighted histogram of the previous HDR frame; and finally, the current HDR frame is obtained based on the long and short exposure parameters of the current HDR frame. Since the weighted histogram of the HDR image is generated through the image statistical information, the effective scene information can be better described through the weighted histogram of the HDR image. In addition, the long and short exposure parameters calculated through the weighted histogram of the HDR image can be more accurate under large variation of the scene, thereby improving the quality of HDR image generation.

### BRIEF DESCRIPTION OF THE DRAWINGS

In order to clearly illustrate the technical solution of the embodiments of the present disclosure, the drawings of the embodiments of the present disclosure are briefly described in the following. It is obvious that the described drawings are only related to some embodiments of the disclosure, and other drawings can be obtained by those ordinary skilled in the art based on the drawings described herein without paying creative efforts.

FIG. 1 is a schematic structural diagram of an imaging device according to an embodiment of the present disclosure;

FIG. 2 is a schematic flowchart of an image generation method according to an embodiment of the present disclosure;

FIG. 3 is a schematic diagram of the regional division of an HDR image according to an embodiment of the present disclosure;

FIG. 4 is a diagram of a relationship between scene photometric data and a luminance weight parameter of a center region according to an embodiment of the present disclosure;

FIG. 5 is an exemplary diagram of a histogram weighting curve according to an embodiment of the present disclosure;

FIG. 6 is a graph of a relationship between a lightest interval and scene photometric data according to an embodiment of the present disclosure;

FIG. 7 is a graph of a relationship between a darkest interval and scene photometric data according to an embodiment of the present disclosure;

FIG. 8 is a graph of a relationship between minWeight and scene photometric data according to an embodiment of the present disclosure;

FIG. 9 is a schematic diagram of a weighted histogram according to an embodiment of the present disclosure;

FIG. 10 is another schematic flowchart of the image generation method according to an embodiment of the present disclosure;

FIG. 11 is still another schematic flowchart of an image generation method according to an embodiment of the present disclosure;

FIG. 12 is a structural block diagram of an image generation apparatus according to an embodiment of the present disclosure; and

FIG. 13 is an internal structural diagram of a computer device according to an embodiment of the present disclosure.

### DETAILED DESCRIPTION OF THE EMBODIMENTS

To further clarify objectives, technical solutions, and advantages of the present application, the following further describes the present application in detail according to embodiments with reference to accompanying drawings. It should be understood that specific embodiments described herein are merely intended to explain rather than to limit the present application.

The following starts with explanations about related technologies.

The natural scene has an extremely wide dynamic range, whereas a dynamic range shot by a widely used imaging device under a single exposure parameter is limited, which is far smaller than the dynamic range of the natural scene. Therefore, an image sequence obtained by multiple times of shooting and imaging by the imaging device using different exposure parameters under the same scene can be fused through multi-exposure image fusion, so as to obtain a high dynamic range (HDR) image with rich contents, reflecting all contents of the natural scene as much as possible.

In the related technologies, an image sensor supporting digital overlap (DOL) technique may be adopted to achieve “quasi-simultaneous” acquisition of a multi-exposure image sequence, which effectively solves the ghost problem existing in conventional multi-exposure HDR imaging technique based on frame acquisition. As a result, the multi-exposure HDR imaging has been widely used in the industry.

However, prior to acquiring the multi-exposure image sequence using the DOL technique, exposure parameters of the imaging device need to be estimated. The exposure parameters may include a long exposure parameter and a short exposure parameter. With the long and short exposure parameters which are properly pre-estimated, it is ensured that the generated HDR image contains reasonable scene information. In addition, the exposure parameters of the imaging device are restricted by the following five factors.

For the first factor, in terms of image quality, the shorter the short exposure, the higher the image noise, and the longer the long exposure, the greater the influence of scene motion. For the second factor, a ratio of the short exposure parameter to the long exposure parameter is restricted by a readout circuit of the imaging device. As for the third factor, the larger the ratio of the short exposure parameter to the long exposure parameter, the larger the decrease in the signal-to-noise ratio of the image after image fusion. When it comes to the fourth factor, the greater the ratio of the short exposure parameter to the long exposure parameter, the higher the possibility of motion ghosting due to the influence of “quasi-simultaneity”. The fifth factor is about the dynamic range of the imaging device, which cannot actually cover the full luminance range of the scene.

In the related technologies, there are many ways to estimate the exposure parameters of the imaging device.

In a first way, the exposure parameters of the imaging device may be implemented by solving an optimal exposure parameter set to cover a full luminance range of a scene, or by solving a maximum signal-to-noise ratio of an HDR image. However, by solving the optimal exposure parameter set or by solving the maximum signal-to-noise ratio of the HDR image, it is sensitive to scene variation, and in the case of large scene variation, the accuracy of the estimated exposure parameters is not high, degrading HDR image quality. In addition, a response model of the imaging device also needs to be estimated and a down-sampled image of the multi-exposure image sequence needs to be obtained in advance, to estimate a full illumination histogram or an illumination map of the scene, thereby resulting in heavy computation and large storage amount.

In a second way, the exposure parameters of the imaging device may be implemented by using a deep learning method. However, if the exposure parameters of the imaging device are estimated by using the deep learning method, although accuracy of the estimated exposure parameters of the imaging device is relatively high, heavy computation and large storage amount are still caused.

In a third way, the exposure parameters of the imaging device may be implemented by using an engineering algorithm based on image statistical values. However, estimating the exposure parameters of the imaging device by using the engineering algorithm of image statistical values usually requires the establishment of a complex scene dataset.

To resolve the foregoing technical problems, an image generation method, an image generation apparatus, a device, a storage medium, and a program product are provided according to embodiments of the present disclosure. The image generation method generates a weighted histogram of an HDR image based on image statistical information, such that effective scene information can be better represented by the weighted histogram of the HDR image. Furthermore, the long and short exposure parameters calculated from the weighted histogram of the HDR image are more accurate when scene variations are large, thereby improving the quality of HDR image generation.

The image generation method provided in the embodiments of the present disclosure may be applied to an image generation apparatus. The image generation apparatus may include a imaging device; or include various personal computers, notebook computers, smart phones, tablet computers, Internet of Things (IoT) devices, and portable wearable devices, each of them equipped with a camera component. The IoT devices may be smart speakers, smart televisions, smart air conditioners, smart vehicle-mounted devices, projection devices, or the like. The portable wearable devices may be smart watches, smart bracelets, head-mounted devices, etc. The head-mounted devices may be virtual reality (VR) devices, augmented reality (AR) devices, smart glasses, or the like.

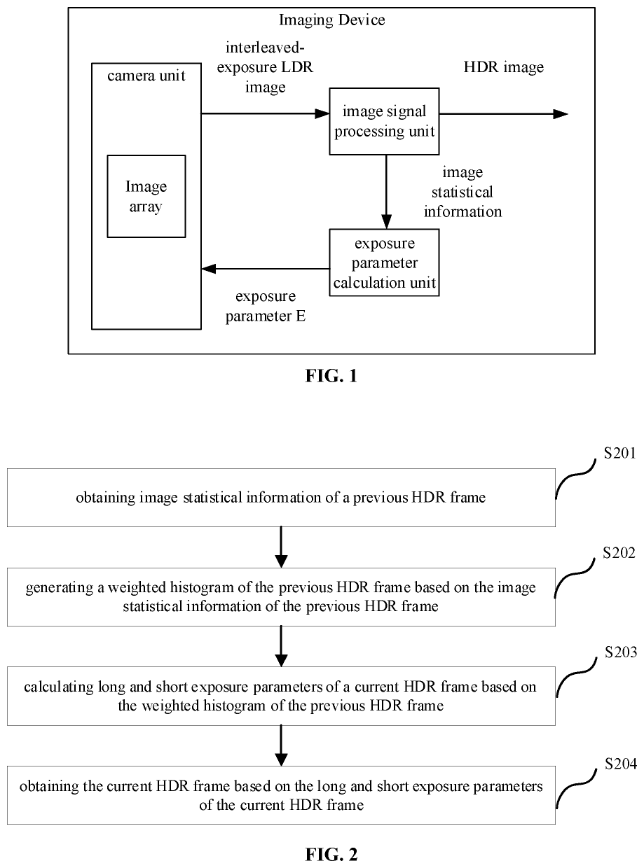

FIG. 1 is a schematic structural diagram of a imaging device according to an embodiment of the present disclosure. As shown in FIG. 1, the imaging device includes a camera unit, an exposure parameter calculation unit, and an image signal processing unit. The camera unit can capture an interleaved-exposure low-dynamic-range image (I_LDR) according to an exposure parameter E output by the exposure parameter calculation unit, and send the I_LDR to the image signal processing unit. The image signal processing unit can synthesize the I_LDR to obtain a high-dynamic-range image (I_HDR), then extract and calculate image statistical information (Statistics_HDR, S_HDR) of the I_HDR, and send the S_HDR to the exposure parameter calculation unit. The exposure parameter calculation unit receives the S_HDR, and calculates an exposure parameter of a next frame of image for the camera unit according to the received S_HDR.

For example, when the imaging device in FIG. 1 is utilized to capture an HDR image, the camera unit may capture an interleaved exposure LDR image I_LDR(N) of a current frame according to an exposure parameter E(N−1) of a previous frame output by the exposure parameter calculation unit. Here, the interleaved exposure may include dual-exposure. Then, the camera unit sends the I_LDR(N) of the current frame to the image signal processing unit, so that the image signal processing unit fuses the I_LDR(N) of the current frame to obtain an HDR image I_HDR(N) of the current frame. The image signal processing unit extracts and calculates image statistical information of the I_HDR(N) of the current frame, and sends the image statistical information of the I_HDR(N) of the current frame to the exposure parameter calculation unit. The exposure parameter calculation unit can calculate the exposure parameter E(N) of the current frame according to the image statistical information of the I_HDR(N) of the current frame, and transmit the exposure parameter E(N) of the current frame to the camera unit for capturing an interleaved-exposure LDR image I_LDR(N+1) of a next frame.

The image generation method provided in an embodiment of the present disclosure may be applied to an imaging device, and the imaging device may be but is not limited to various personal computers, notebook computers, smart phones, tablet computers, IoT devices, and portable wearable devices each having a camera component. The IoT devices may be smart speakers, smart televisions, smart air conditioners, smart vehicle-mounted devices, projection devices, or the like. The portable wearable devices may be smart watches, smart bracelets, head-mounted devices, etc. The head-mounted devices may be virtual reality (VR) devices, augmented reality (AR) devices, smart glasses, or the like.

In an exemplary embodiment, an image generation method is provided, and it is exemplarily described based on a case that the image generation method is applied to an imaging device. As shown in FIG. 2, the method includes steps S202-S204.
S201 includes: obtaining image statistical information of a previous HDR frame.

In the present disclosure, before capturing an HDR image, the imaging device may first obtain image statistical information of the previous HDR frame.

It should be understood that the image statistical information is not limited to any specific type in the embodiment of the present disclosure. In some embodiments, the image statistical information may include an exposure parameter and statistical luminance information.

For example, the statistical luminance information may be expressed in a form of a luminance histogram, a spatial average luminance value of image blocks, or the like. The exposure parameter may be a long/short exposure parameter of the previous HDR frame, including an exposure time, an f-number, an ISO speed, etc.
S202 includes: generating a weighted histogram of the previous HDR frame based on the image statistical information of the previous HDR frame.

In this step, after obtaining the image statistical information of the previous HDR frame, the imaging device may generate the weighted histogram of the previous HDR frame based on the image statistical information of the previous HDR frame.

The weighted histogram may be a histogram in a special form, which introduces weight parameters to more finely reflect data distribution features. It should be understood that the weighted histogram in the embodiment of the present disclosure may be configured to describe effective scene information of the previous HDR frame, where the effective scene information may include scene luminance.

In some embodiments, the imaging device may first select a lightest image block in the previous HDR frame as a photometry target and perform photometric measurement on the lightest image block based on the exposure parameter of the previous HDR frame to obtain scene photometric data of the lightest image block. Next, the imaging device performs weighting processing on the statistical luminance information of a center region of the previous HDR frame based on the scene photometric data of the lightest image block, to obtain a weighted region luminance of the center region. Then, the imaging device divides a luminance range of the previous HDR frame into multiple luminance intervals based on the weighted region luminance of the center region, and calculates respective weighting parameters for curve segments in a histogram weighting curve that correspond to the multiple luminance intervals. Finally, the imaging device generates the weighted histogram of the previous HDR frame based on the weighting parameters of the curve segments corresponding to the multiple luminance intervals in the histogram weighting curve.

The photometry may be scene photometry, which can perform photometric measurement on the previous HDR frame by using the exposure parameters of the previous HDR frame, where the lightest image block is taken as the photometry target. The lightest image block may be a potential scene light source or an object having a highest reflectivity in the scene. For example, the scene photometry may be expressed by following formula (1):

$$L v = {log}_{10} ( \frac{1}{K c} \times \frac{{( f s )}^{2}}{t s} Y max ) \qquad ( 1 )$$

where Lv is the scene photometric data; Kc is a camera constant of the imaging device, which can be calibrated; ts is the exposure time of the previous HDR frame; fs is the f-number; s is the ISO speed; Y refers to the luminance value of an image block and Ymax refers to the luminance value of the lightest image block, i.e., max (Y [N]).

It should be understood that the aforesaid scene photometric data may be utilized to derive prior knowledge based on scene classification. For example, in a high-illumination scene with a large value of Lv such as an outdoor sunny scene, dark region information such as a human face and an object is usually information of interest in an HDR image; in a low-illumination scene with a small value of Lv such as a night scene and a stage scene, information of light regions such as a firework, the moon, colorful light bulbs, and the stage center is usually information of interest in the HDR image; and in a normal-illumination scene with a medium value of Lv such as an indoor normal light source, a region of interest can be the center of HDR frame. Alternatively, a region of interest in the HDR image may be demarcated by determining whether the luminance distribution of the image conforms to spatial-luminance center distribution probability.

In some embodiments, the HDR image may be divided into regions, for example, the HDR image may be divided into the center region, a pericentral region, and a periphery region according to positions. In this way, the statistical luminance information may be weighted by using the scene photometric data of the lightest image block to obtain the weighted region luminance of the center region.

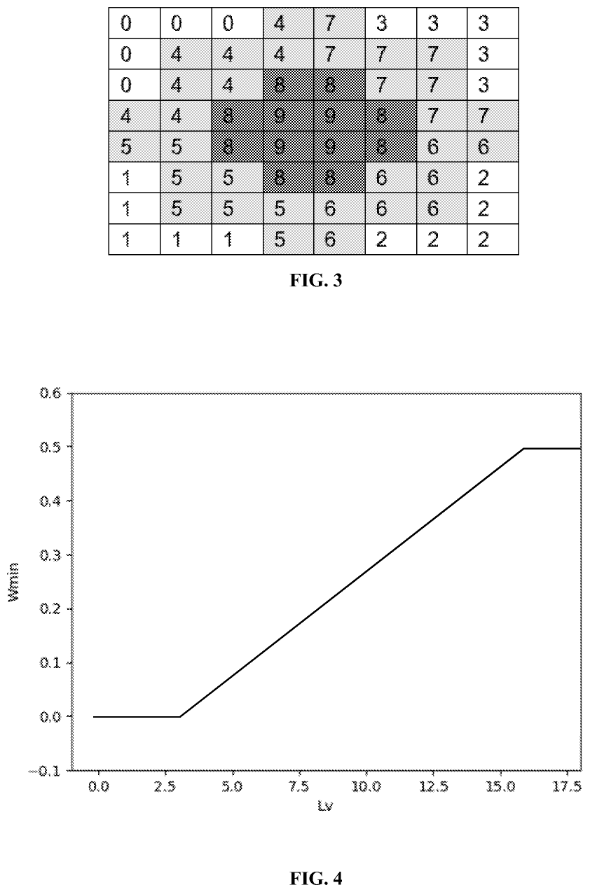

It should be understood that the embodiments of the present application do not limit the manner of dividing an HDR image into regions, and the division may be performed by image blocks. For example, FIG. 3 is a schematic diagram of the regional division of the HDR image according to an embodiment of the present disclosure. As shown in FIG. 3, for example, input image statistical information includes 32×32 image blocks, adjacent 4×4 image blocks may be combined into a single large block, so there are 8×8 large blocks in total. Then, the 8×8 large blocks are divided into 10 groups, and the 10 groups are classified based on positions of the groups. For example, Group 0, Group 1, Group 2, and Group 3 are classified as the periphery region; Group 4, Group 5, Group 6, and Group 7 are classified as the pericentral region; and Group 8 and Group 9 are classified as the center region.

It should be understood that, how the statistical luminance information of the center region of the previous HDR frame is weighted is not limited in the embodiments of the present disclosure. In some embodiments, a luminance weight parameter of the center region of the previous HDR frame may be first determined based on the scene photometric data of the lightest image block. Then, weighting processing is performed on the maximum luminance, minimum luminance and average luminance of the center region in the statistical luminance information according to the luminance weight parameter of the center region of the previous HDR frame, to obtain the weighted region luminance of the center region.

For example, the weighting processing to obtain the weighted region luminance of the center region may be expressed by following formula (2):

Y_{center}=0.5*Y_{meanCenter}+Wₘᵢₙ*Y_{minCenter}+(0.5−Wₘᵢₙ)*Y_{maxCenter} (2)

where Y_{center} is the weighted region luminance of the center region; Y_{meanCenter} is an average region luminance of the center region, Y_{meanCenter}=mean(Y[i]); Y_{minCenter} is a minimum region luminance of the center region, Y_{minCenter}=min(Y[i]); Y_{maxCenter} is a maximum region luminance of the center region, Y_{maxCenter}=max(Y[i]); (groupID(Y[i])=8∥groupID(Y[i])=9), that is, the center region includes image blocks with groupID of 8 and groupID of 9; and Wₘᵢₙ is the luminance weight parameter of the center region.

It should be understood that the luminance weight parameter of the center region may be utilized to determine weight allocation of maximum and minimum photometric values in the center region. In some embodiments, the luminance weight parameter of the center region may be associated with the scene photometric data Lv, and correspondingly determined by the scene photometric data Lv.

For example, FIG. 4 is a diagram of a relationship between the scene photometric data and the luminance weight parameter of the center region according to an embodiment of the present disclosure. As can be seen from FIG. 4, the region of interest is a dark region in a bright scene, and the luminance weight parameter of the center region allocates higher weight to the dark region; on the contrary, a bright region is the primary focus in a dark scene, and the luminance weight parameter of the center region allocates higher weight to the light region.

It should be understood that the division of the multiple luminance intervals is not limited in the embodiments of the present disclosure, and the number and values of the luminance intervals may be set according to actual situations. For example, the luminance range [0, maxvalue] of the previous HDR frame may be divided into five luminance intervals with reference to the weighted region luminance of the center region, and the five luminance intervals may be shown in formula (3):

$$\{ \begin{matrix}darkest : [ 0 , {Y}_{c e n t e r} - 3 * step ] \\ darker : [ {Y}_{c e n t e r} - 3 * step , {Y}_{c e n t e r} - 2 * step ] \\ similar : [ {Y}_{c e n t e r} - 2 * step , {Y}_{c e n t e r} + 2 * step ] \\ lighter : [ {Y}_{c e n t e r} + 2 * step , {Y}_{c e n t e r} + 3 * step ] \\ lightest : [ {Y}_{c e n t e r} + 3 * step , max value ]\end{matrix} \qquad ( 3 )$$

where Y_{center} is the weighted region luminance of the center region; step is a luminance step, and step=Y_{center}*Kₛₜₑₚ, where Kₛₜₑₚ is a preset parameter.

Referring to formula (3), the five luminance intervals include a darkest interval, a darker interval, a similar interval, a lighter interval, and a lightest interval, respectively. An image block whose luminance value falls within the similar interval may be approximately classified as an image block whose luminance is close to that of a central image block; a darker image block falls within the darkest interval or the darker interval; and a lighter image block falls within the lighter interval or the lightest interval.

The following describes how to calculate weighting parameters of curve segments corresponding to the multiple luminance intervals in the histogram weighting curve.

In some embodiments, the imaging device may first determine a illumination-prior center distribution probability (which can also be referred to as weak center distribution probability) of the previous HDR frame based on the scene photometric data of the lightest image block. Then, the imaging device may determine a spatial-luminance center distribution probability (which can also be referred to as strong center distribution probability) of the previous HDR frame based on the weighted region luminance of the center region. Finally, the imaging device may determine, based on the illumination-prior center non-saliency probability and the spatial-luminance center distribution probability, the weighting parameters of the curve segments corresponding to the multiple luminance intervals in the histogram weighting curve.

It should be understood that the illumination-prior center non-saliency probability be a center interested degree index P_{noncenter} based on a scene prior.

In some embodiments, the imaging device may first determine, based on the scene photometric data of the lightest image block, a target scene type corresponding to the previous HDR frame and a condition for filtering block(s) of interest corresponding to the target scene type. Then, the imaging device may determine, based on the condition for filtering block(s) of interest, the quantity of block(s) of interest in the pericentral region in the previous HDR frame. Finally, the imaging device quantifies the quantity of block(s) of interest in the pericentral region in the previous HDR frame into the illumination-prior center non-saliency probability of the previous HDR frame.

For example, the scene type may include a dark scene, a bright scene, and a normal scene, and the target scene type corresponding to the previous HDR frame may be determined by comparing the scene photometric data of the lightest image block with thresholds. A dark scene threshold is Th_d and a bright scene threshold is Th_l. If the scene photometric data is less than Th_d, it is the dark scene. If the scene photometric data is greater than Th_l, it is the bright scene. If the scene photometric data is greater than or equal to Th_d and is less than or equal to Th_l, it is the normal scene.

The dark scene threshold Th_d and the bright scene threshold Th_l may be specifically set or calibrated according to actual situations, which are not limited in the embodiments of the present disclosure.

For example, for different scene types, different conditions for filtering the block of interest may be set. The condition for filtering block(s) of interest in the pericentral region under the bright scene (for example, an outdoor sunny scene) is a dark region. The condition for filtering block(s) of interest in the pericentral region under the dark scene (for example, an indoor dark scene or a night scene) is a light region. The prior knowledge on the illumination condition of a normal-illumination scene is attenuated, such that no blocks of interest exist in the pericentral region based on this illumination condition-related prior knowledge.

Exemplarily, according to different conditions for filtering the block of interest, the quantity Cntᵣₒᵢ of blocks of interest in the pericentral region (image blocks with groupIDs ranging from 4 to 7) is counted, and then the quantity Cntᵣₒᵢ of blocks of interest is quantified into the illumination-prior center non-saliency probability by formula (4):

P_{noncenter}=Cntᵣₒᵢ*K_{pnc} (4)

where P_{noncenter} is the illumination-prior center non-saliency probability, Cntᵣₒᵢ is the quantity of block(s) of interest, and K_{pnc} is a preset empirical parameter.

It should be understood that the spatial-luminance center distribution probability may be a high spatial-luminance center distribution probability P_{center} based on a position prior.

In some embodiments, the imaging device may first determine, based on the weighted region luminance of the center region, quantities of light blocks and dark blocks in the pericentral region in the previous HDR frame. Next, the imaging device determines the proportion and the spatial positional symmetry parameter of the light blocks in the pericentral region based on the quantity of the light blocks in the pericentral region; it also determines the proportion and the spatial symmetry parameter of the dark blocks in the pericentral region based on the quantity of the dark blocks in the pericentral region. Then, the imaging device determines a bright center distribution probability and a dark center distribution probability based on the proportions and the spatial symmetry parameters of the light blocks and the dark blocks in the pericentral region. Finally, the imaging device determines the spatial-luminance center distribution probability of the previous HDR frame based on the bright center distribution probability and the dark center distribution probability.

For example, criteria for identifying the light and dark blocks in the pericentral region may be determined based on the weighted luminance of the center region. For example, the criteria for identifying the light blocks is: Y[n]>Y_{center}+2*step and the criteria for identifying the dark blocks is: Y[n]<Y_{center}−2*step. Then, the quantity Cnt_{L}[i] of the light blocks in the pericentral region may be determined according to the criteria for determining the light blocks, and the quantity Cnt_{D}[i] of the dark blocks in the pericentral region may be determined according to the criteria for determining the dark blocks. Here, Y[n] is the luminance of an image block in the pericentral region, Y_{center} is the weighted luminance of the center region, step is a luminance step, and 4<=i<=7, i represents groupID.

For example, after the quantities of the light and dark blocks in the pericentral region are determined, the proportions and the spatial symmetry parameters of the light and dark blocks in the pericentral region may be calculated. The proportion of the light blocks in the pericentral region may be calculated by Formula (5), and the proportion of the dark blocks in the pericentral region may be calculated by Formula (6). The spatial symmetry parameters include the vertical spatial symmetry parameter for light blocks, the horizontal spatial symmetry parameter for light blocks, the vertical spatial symmetry parameter for dark blocks, and the horizontal spatial symmetry parameter for dark blocks. The vertical spatial symmetry parameter for light blocks may be calculated by Formula (7), the horizontal spatial symmetry parameter for light blocks by Formula (8), the vertical spatial symmetry parameter for dark blocks by Formula (9), and the horizontal spatial symmetry parameter for dark blocks by Formula (10).

$${Ratio}_{L} = \frac{{\sum }_{i = 4}^{7} {Cnt}_{L} [ i ]}{{NumB}_{noncen}} \qquad ( 5 )$$

$${Ratio}_{D} = \frac{{\sum }_{i = 4}^{7} {Cnt}_{D} [ i ]}{{NumB}_{noncen}} \qquad ( 6 )$$

$${symUD}_{L} = \frac{min ( {Cnt}_{L} [ 4 ] + {Cnt}_{L} [ 7 ] , {Cnt}_{L} [ 5 ] + {Cnt}_{L} [ 6 ] )}{max ( {Cnt}_{L} [ 4 ] + {Cnt}_{L} [ 7 ] , {Cnt}_{L} [ 5 ] + {Cnt}_{L} [ 6 ] )} \qquad ( 7 )$$

$${symLR}_{L} = \frac{min ( {Cnt}_{L} [ 4 ] + {Cnt}_{L} [ 5 ] , {Cnt}_{L} [ 6 ] + {Cnt}_{L} [ 7 ] )}{max ( {Cnt}_{L} [ 4 ] + {Cnt}_{L} [ 5 ] , {Cnt}_{L} [ 6 ] + {Cnt}_{L} [ 7 ] )} \qquad ( 8 )$$

$${symUD}_{D} = \frac{min ( {Cnt}_{D} [ 4 ] + {Cnt}_{D} [ 7 ] , {Cnt}_{D} [ 5 ] + {Cnt}_{D} [ 6 ] )}{max ( {Cnt}_{D} [ 4 ] + {Cnt}_{D} [ 7 ] , {Cnt}_{D} [ 5 ] + {Cnt}_{D} [ 6 ] )} \qquad ( 9 )$$

$${symLR}_{D} = \frac{min \text{?} ( {Cnt}_{D} [ 4 ] + {Cnt}_{D} [ 5 ] , {Cnt}_{D} [ 6 ] + {Cnt}_{D} [ 7 ] )}{max \text{?} ( {Cnt}_{D} [ 4 ] + {Cnt}_{D} [ 5 ] , {Cnt}_{D} [ 6 ] + {Cnt}_{D} [ 7 ] )} \qquad ( 10 )$$

Ratio_{L} is the proportion of the light blocks in the pericentral region, Ratio_{D} is the proportion of the dark blocks in the pericentral region, symUD_{L} is the vertical spatial symmetry parameter, symLR_{L} is the horizontal spatial symmetry parameter for the light block, symUD_{D} is the vertical spatial symmetry parameter for the dark blocks, symLR_{D} is the horizontal spatial symmetry parameter for the dark block, and NumB_{noncen} is the quantity of image blocks in the pericentral region.

Exemplarily, the bright center distribution probability P_{centerL} may be calculated by Formula (11), and the dark center distribution probability P_{centerD} may be calculated by Formula (12). Then, the maximum value of the light center distribution probability and the dark center distribution probability is taken to obtain a spatial-luminance center distribution probability P_{center}.

P_{centerL}=Ratio_{L}*symUD_{L}*symLR_{L} (11)

P_{centerD}=Ratio_{D}*symUD_{D}*symLR_{D} (12)

It should be understood that the embodiments of the present application do not limit the manner of determining the weighting parameters of the curve segments corresponding to multiple luminance intervals in the histogram weighting curve based on the illumination-prior center non-saliency probability and the spatial-luminance center distribution probability. In some embodiments, the histogram weighting curve may be divided into multiple curve segments, and weighting parameters of the multiple curve segments may be calculated respectively based on the illumination-prior center non-saliency probability and the spatial-luminance center distribution probability.

Exemplarily, the curve may be divided into linear curve segments according to the result of adaptive luminance interval partitioning, that is, the division manner of the curve segments may be consistent with the division manner of the luminance intervals, for example, as shown in Formula (3). Correspondingly, the histogram weighting curve may be composed of linear functions corresponding to the multiple curve segments.

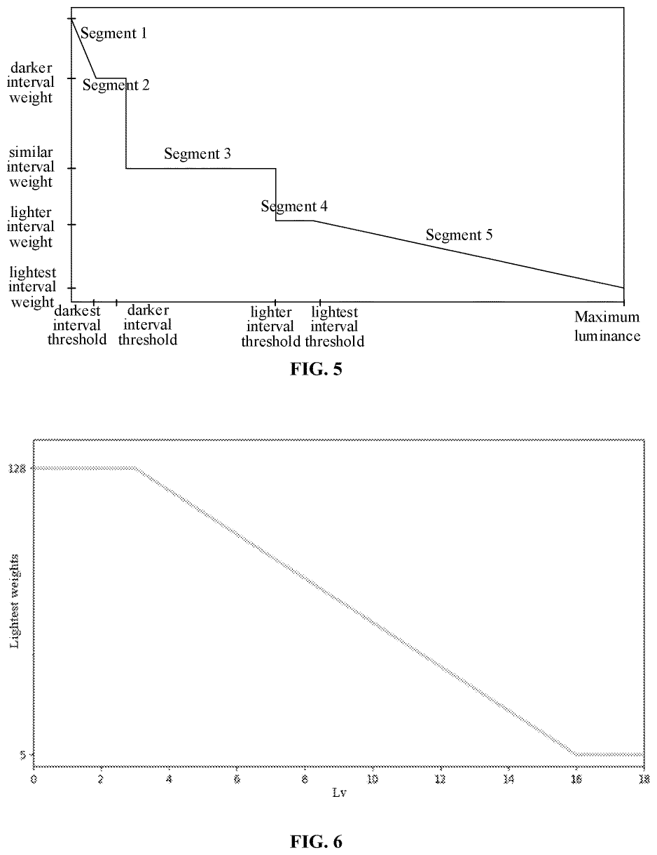

For example, FIG. 5 is an example diagram of the histogram weighting curve according to an embodiment of the present disclosure. As shown in FIG. 5, under strong ambient light, curve segment 3 is the weight of the similar interval to the center region; segmented curves 1 and 2 are weights of the darkest interval and the darker interval in the image respectively; and curve segments 4 and 5 are weights of the lighter interval and the lightest interval in the image, respectively. Under the strong ambient light, weights of dark regions are increased, and weights of light regions are decreased. Meanwhile, to apply the fuzzy control principle, segmented curves 2, 3 and 4 are set as plateaus, so that luminance values in the same luminance interval share the same weight, and the weights of different luminance intervals can be distinguished rapidly. For example, start points and end points of linear functions corresponding to each segmented curve may be as shown in Table 1.

TABLE 1

| Curve | | |
|---|---|---|
| Segments | Start Point [x, y] | End Point [x, y] |
| darkest | [0, darkestWeight] | [Ycenter − 3step, darkestWeight] |
| darker | [Ycenter − 3step, darkerWeight] | [Ycenter − 2step, darkerWeight] |
| similar | [Ycenter − 2step, similarWeight] | [Ycenter + 2step, similarWeight] |
| lighter | [Ycenter + 2step, lighterWeight] | [Ycenter + 3step, lighterWeight] |
| lightest | [Ycenter + 3step, lighterWeight] | [maxvalue, lightestWeight] |

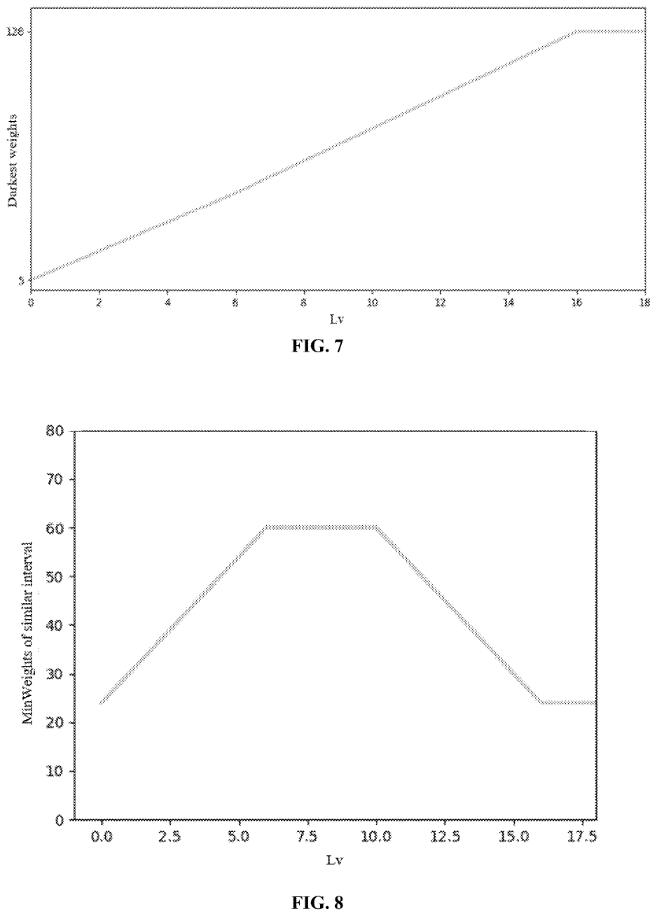

For the weighting parameter of the lightest interval and the weighting parameter of the darkest interval, it should be understood that under the low-light scene, a weight of a light region is higher, and under the strong ambient light scene, a weight of a dark region is higher. The initial values of the above two weighting parameters are determined based on the scene photometric data, with the corresponding relationship curves shown in FIG. 6 (for the lightest interval) and FIG. 7 (for the darkest interval) respectively. Under a center contrast distribution condition, the weights should be reduced,—this physically means that a larger value of Pcenter (the spatial-luminance center distribution probability) represents a stronger prior of luminance spatial distribution, namely the human eye attention mechanism is more focused on the image center, while the scene photometry-based prior is weakened accordingly. The initial values are further adjusted based on Pcenter, and the final weighting parameter (darkestWeight) of the darkest interval may be expressed by Formula (13), and the final weighting parameter (lighttestWeight) of the lightest interval may be expressed by Formula (14):

darkestWeight=darkestWeight*(1−P_{center})+Minweight*P_{center} (13)

lightestWeight=lightestWeight*(1−P_{center})+Minweight*P_{center} (14)

where Minweight is a preset empirical parameter.

The weighting parameter of the similar interval may be set to the same weight value as that of the the central image block. That is, the weighting parameter of the similar interval is assigned to the image blocks with similar luminance to the center region. For example, an initial value of the weighting parameter of the similar interval may be shown in Formula (15):

similarweight=defalutWeight−K_{weight}*P_{noncenter}*(1−P_{center}) (15)

where K_{weight} and defaultWeight are preset empirical parameters.

It should be understood that from the Formula (15), the smaller the P_{noncenter}, the fewer the quantity of block(s) of interest in the pericentral region based on the prior knowledge of the scene photometry, the larger the P_{center}, the higher the probability of the luminance spatial distribution conforming to the central distribution characteristic, and correspondingly, the larger the value of similarweight.

Based on this, to ensure that the central image block is neither blown out nor excessively dark, a minimum value constraint shall be imposed on similarweight. The minimum constraint of similarweight may be shown in Formula (16). A curve diagram of a relationship between minWeight (the minimum value of similarweight) and the scene photometric data is shown in FIG. 8.

similarweight=max(similarweight,minWeight) (16)

The weighting parameter of the lighter interval and the weighting parameter of the darker interval may be determined by means of averaging. For example, the weighting parameter of the darker interval may be calculated by Formula (17), and the weighting parameter of the lighter interval may be calculated by Formula (18):

darkerWeight=0.5*(darkestWeight+similarWeight) (17)

lighterWeight=0.5*(lightestWeight+similarWeight) (18)

It should be understood that after the weighting parameters of the corresponding curve segments in the histogram weighting curve are determined, an original image histogram Hist [M] may be weighted using the weighting parameters of the each curve segment to obtain the weighted histogram of the HDR image. The weighted histogram may be expressed by Formula (19):

$$H i s {t}_{w} [ n ] = ( weight [ n ] * H i s t [ n ] ) / ( {\sum }_{n = 0}^{M} weight [ n ] * H i s t [ n ] ) \qquad ( 19 )$$

In the present disclosure, first, the weighted histogram is generated based on the scene photometric data and the luminance distribution of the image blocks, which ensures that the weighted histogram effectively characterizes scene luminance information without establishing any complex scene dataset. Secondly, the adaptive partitioning method based on the central photometry reference conforms to the scene photometry prior and while ensuring effective retention of the luminance of the center region. Thirdly, since the histogram weight generation equation adopts the fuzzy control principle, effective weights can be more efficiently assigned to different curve segments. Finally, the scene photometry strategy and the luminance distribution analysis result are effectively quantified and integrated into the weight curve equation, which can stably characterization the effective luminance range of the same scene and avoid the stroboscopic problem.
S203 includes: calculating long and short exposure parameters of a current HDR frame based on the weighted histogram of the previous HDR frame.

In this step, after generating the weighted histogram of the previous HDR frame, the imaging device may calculate the long and short exposure parameters of the current HDR frame based on the weighted histogram of the previous HDR frame.

In some embodiments, the imaging device may first obtain a noise threshold and a saturation threshold of an image sensor. Then, the imaging device determines a ratio of a short exposure gain value to a long exposure gain value of the current HDR frame based on the weighted histogram of the previous HDR frame, the noise threshold, and the saturation threshold. For a DOL camera, the hardware constraint is defined by the maximum allowable long-short exposure time ratio ERmax, and long-short exposure time ratio of previous frame is ERpre, the short-long gain threshold GainTh=ERpre/ERmax is derived therefrom, which is the minimum allowable value of the ratio of the short exposure gain to the long exposure gain. If the ratio of the short exposure gain value to the long exposure gain value is greater than or equal to the gain threshold GainTh, the initial exposure parameters of the current HDR frame corresponding to the weighted histogram of the previous HDR frame are taken as the long and short exposure parameters of the current HDR frame. If the ratio of the short exposure gain value to the long exposure gain value is is greater than or equal to the gain threshold GainTh, an exposure optimization equation of the weighted histogram is solved in accordance with the exposure gain constraint to obtain the long and short exposure parameters of the current HDR frame.

The exposure gain constraint is that the ratio of the short exposure gain value to the long exposure gain value is equal to the gain threshold GainTh. An optimization objective of the exposure optimization equation is to minimize a proportion of the weighted histogram falling outside a target region, and the target region is a region bounded by the noise threshold and the saturation threshold.

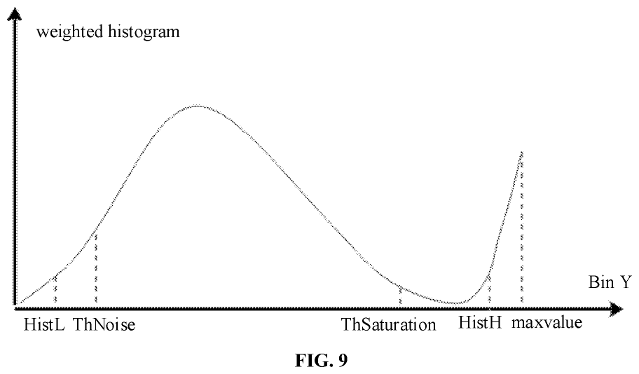

For example, FIG. 9 is a schematic diagram of the weighted histogram according to an embodiment of the present disclosure. The short exposure gain value and the long exposure gain value can be respectively determined based on the weighted histogram of the HDR image, the noise threshold, and the saturation threshold. FIG. 9 illustrates the corresponding variables and the state prior to exposure parameter adjustment.

For example, the long exposure parameter is configured to preserve valid information in a dark region of the image and shall satisfy Formula (20); and on the premise of satisfying Formula (20), the long exposure gain value gainLong can be calculated by formula (21):

HistL≥ThNoise (20)

gainLong=ThNoise/HistL (21)

where HistL is a low 3% quantile of the weighted histogram, which can quantitatively represent the effective information in a darkest region of the image; and ThNoise is the noise threshold, which can be derived from the image sensor noise model or set as a preset constant.

For example, the short exposure parameter is configured to preserve valid information in a light region of the image and shall satisfy Formula (22); and on the premise of satisfying Formula (22), the short exposure gain value gainShort can be calculated by Formula (23):

HistH≤ThSaturation (22)

gainShort=ThSaturation/HistH (23)

where HistH is a high 98% quantile of the weighted histogram, which can quantitatively characterize valid information in a lightest region of the image; and ThSaturation is the saturation threshold, which can be obtained according to an image sensor model or set as a preset constant.

It should be understood that, if the imaging device adopts a DOL camera, due to the hardware constraints of the DOL camera, gainShort and gainLong shall satisfy the relevant constraint requirements: gainShort/gainLong≤ThGain. For a DOL camera, the hardware constraint is defined by the maximum allowable long-short exposure time ratio ERmax, and long-short exposure time ratio of previous frame is ERpre, and the gain threshold GainTh=ERpre/ERmax is derived therefrom, which is the minimum allowable value of the ratio of the short exposure gain to the long exposure gain. It shall be further understood that, the long exposure gain value gainLong calculated from formula (21) and the short exposure gain value gainShort calculated from formula (23) are determined based on the weighted histogram of the previous HDR frame; so the obtained long exposure gain value gainLong and the obtained short exposure gain value gainShort correspond to the initial exposure parameters of the current HDR frame corresponding to the weighted histogram of the previous HDR frame.

Correspondingly, if the ratio of the short exposure gain value to the long exposure gain value is greater than or equal to the gain threshold GainTh, the imaging device may directly use the initial exposure parameters of the current HDR frame corresponding to the weighted histogram of the previous HDR frame as the long and short exposure parameters of the current HDR frame. If the ratio of the short exposure gain value to the long exposure gain value is less than the gain threshold GainTh, the imaging device needs to further solve the exposure optimization equation of the weighted histogram in accordance with the exposure gain constraint.

Exemplarily, an initial value of the ratio of the short exposure gain value to the long exposure gain value may be in a status as shown in formula (24). The exposure optimization equation to be solved may be as shown in formula (25); and on the premise of ensuring that the ratio of the short exposure gain value to the long exposure gain value is equal to gain threshold GainTh in accordance with the exposure gain constraint, the proportion of the weighted histogram falling outside the target region [ThNoise, ThSaturation] may be minimized in the process of solving the exposure optimization equation. Since the number of bins in the obtained histogram is limited, e.g., there may be 64 bins, or 128 bins, or 256 bins, an optimal solution of the exposure optimization equation may be obtained by an exhaustive method. As shown in formula (25), the solving needs to traverse two ranges respectively related to minhistL and minhistH, where the maxvalue shown in FIG. 9 refers to the maximum sequence number of the bins. Here, minhistL represents the target mapped value of the original HistL under the candidate long exposure gain GainLong during the solving process of the exposure optimization equation, and the candidate long exposure gain GainLong is calculated by the formula: GainLong=HistL/minhistL. The minimum of the long exposure parameter minhistL can be obtained through formula (26), and a maximum of the long exposure parameter minhistL can be obtained through formula (28). In addition, minhistH represents the target mapped value of the original HistH under the candidate short exposure gain GainShort during the solving process of the exposure optimization equation, and the candidate short exposure gain GainShort is calculated by the formula: GainShort=HistH/minhistH. The minimum of the short exposure parameter minhistH can be obtained through formula (27), and a maximum of the short exposure parameter minhistH can be obtained through formula (29).

$$\frac{gainShort}{g a i n L o n g} > ThGain \qquad ( 24 )$$

$$Min ( {\sum }_{n = 0}^{minhistL} H i s {t}_{w} [ n ] + {\sum }_{m = minhistH}^{maxbin} H i s {t}_{w} [ m ] ) \qquad ( 25 )$$

$${Min}_{minhistL} = H i s t L * \frac{ThSaturation}{HistH * ThGain} \qquad ( 26 )$$

$${Min}_{minhistH} = ThSaturation \qquad ( 27 )$$

$${Max}_{minhistL} = ThNoise \qquad ( 28 )$$

$${Max}_{minhistH} = H i s t H * \frac{T h N o i s e * T h G a i n}{H i s t L} \qquad ( 29 )$$

In the present disclosure, the exposure parameter target equation is proposed based on the weighted histogram, the exposure parameters are solved through the optimization equation, and the algorithm effectively avoids introducing noise and saturation distortion information within the dynamic range of the camera, and effectively captures scene information in the case of insufficient dynamic range of the camera.
S204 includes: obtaining the current HDR frame based on the long and short exposure parameters of the current HDR frame.

In the step, after calculating the long and short exposure parameters of the current HDR frame, the imaging device may obtain the current HDR frame based on the long and short exposure parameters of the current HDR frame.

In some embodiments, the imaging device may capture a current frame of interleaved exposure LDR image based on the long and short exposure parameters of the current HDR frame. Then, the imaging device synthesizes the current frame of interleaved exposure LDR image to obtain the current HDR frame.

According to the image generation method provided in the embodiment of the present disclosure, first, the image statistical information of the previous HDR frame is obtained; second, the weighted histogram of the previous HDR frame is generated based on the image statistical information of the previous HDR frame, where the weighted histogram is configured to describe effective scene information of the previous HDR frame; second, long and short exposure parameters of the current HDR frame are calculated based on the weighted histogram of the previous HDR frame; and finally, the current HDR frame is obtained based on the long and short exposure parameters of the current HDR frame. Since the weighted histogram of the HDR image is generated through the image statistical information, the effective scene information can be better described through the weighted histogram of the HDR image, and the long and short exposure parameters calculated through the weighted histogram of the HDR image can be more accurate under large variation of the scene, thereby improving the generation effect of HDR images.

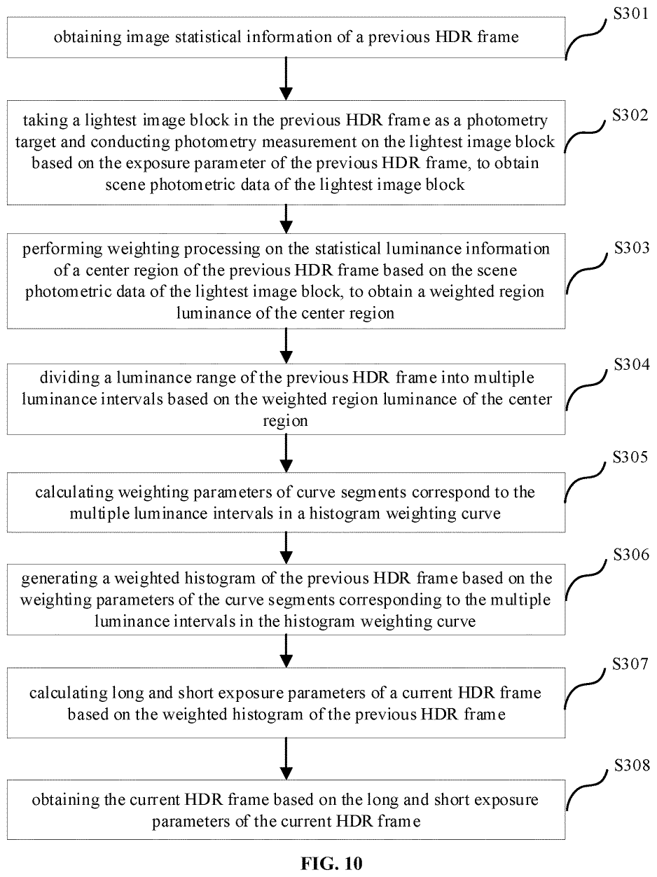

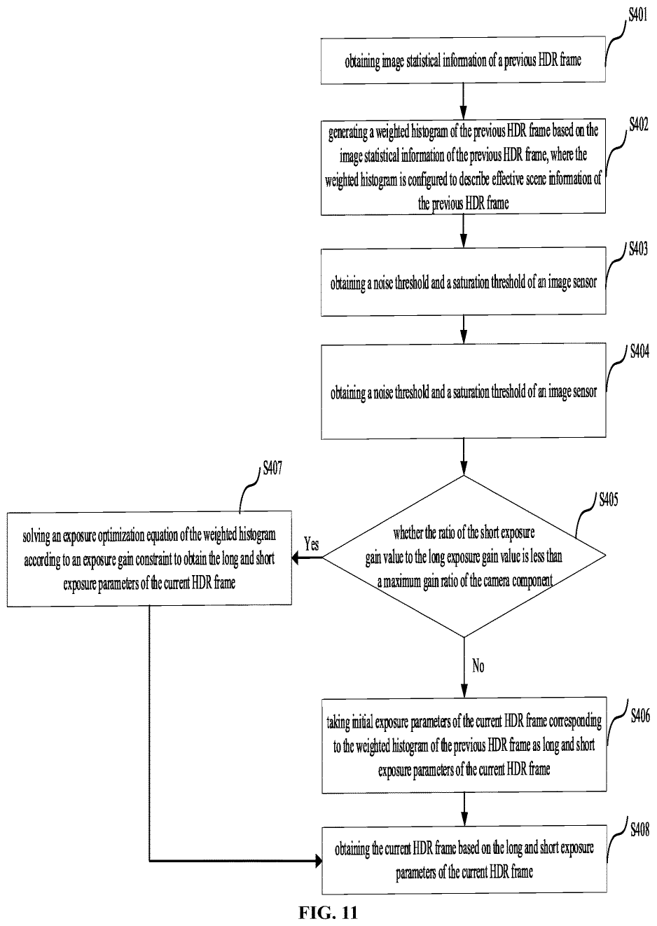

The following describes how to generate a weighted histogram of an HDR image. FIG. 10 is another schematic flowchart of an image generation method according to an embodiment of the present disclosure. As shown in FIG. 10, the image generation method includes steps S301 to S308.
S301 includes: obtaining image statistical information of a previous HDR frame.

The image statistical information includes an exposure parameter and statistical luminance information.
S302 includes: taking a lightest image block in the previous HDR frame as a photometry target and conducting photometry measurement on the lightest image block based on the exposure parameter of the previous HDR frame, to obtain scene photometric data of the lightest image block.
S303 includes: performing weighting processing on the statistical luminance information of a center region of the previous HDR frame based on the scene photometric data of the lightest image block, to obtain a weighted region luminance of the center region.
S304 includes: dividing a luminance range of the previous HDR frame into multiple luminance intervals based on the weighted region luminance of the center region.
S305 includes: calculating weighting parameters of curve segments correspond to the multiple luminance intervals in a histogram weighting curve.
S306 includes: generating a weighted histogram of the previous HDR frame based on the weighting parameters of the curve segments corresponding to the multiple luminance intervals in the histogram weighting curve.
S307 includes: calculating long and short exposure parameters of a current HDR frame based on the weighted histogram of the previous HDR frame.
S308 includes: obtaining the current HDR frame based on the long and short exposure parameters of the current HDR frame.

The following describes how to calculate long and short exposure parameters of a current HDR frame. FIG. 11 is still another schematic flowchart of an image generation method according to an embodiment of the present disclosure. As shown in FIG. 11, the image generation method includes steps S401 to S408.
S401 includes: obtaining image statistical information of a previous HDR frame.
S402 includes: generating a weighted histogram of the previous HDR frame based on the image statistical information of the previous HDR frame, where the weighted histogram is configured to describe effective scene information of the previous HDR frame.
S403 includes: obtaining a noise threshold and a saturation threshold of an image sensor.
S404 includes: determining a ratio of a short exposure gain value to a long exposure gain value of a current HDR frame based on the weighted histogram of the previous HDR frame, the noise threshold, and the saturation threshold.
S405 includes: determining whether the ratio of the short exposure gain value to the long exposure gain value is less than the minimum allowable gain ratio of the image sensor.

If the determination result is positive (Yes), S407 is performed; if the determination result is negative (No), S406 is performed.
S406 includes: taking initial exposure parameters of the current HDR frame corresponding to the weighted histogram of the previous HDR frame as long and short exposure parameters of the current HDR frame.
S407 includes: solving an exposure optimization equation of the weighted histogram according to an exposure gain constraint to obtain the long and short exposure parameters of the current HDR frame.

The exposure gain constraint is that the ratio of the short exposure gain value to the long exposure gain value is equal to the minimum allowable gain ratio. An optimization objective of the exposure optimization equation is to minimize a proportion of the weighted histogram outside a target region, and the target region is a region bounded by the noise threshold and the saturation threshold.
S408 includes: obtaining the current HDR frame based on the long and short exposure parameters of the current HDR frame.

According to the image generation method provided in the embodiment of the present disclosure, first, the image statistical information of the previous HDR frame is obtained; second, the weighted histogram of the previous HDR frame is generated based on the image statistical information of the previous HDR frame, where the weighted histogram is configured to describe effective scene information of the previous HDR frame; second, the long and short exposure parameters of the current HDR frame are calculated based on the weighted histogram of the previous HDR frame; and finally, the current HDR frame is obtained based on the long and short exposure parameters of the current HDR frame. Since the weighted histogram of the HDR image is generated through the image statistical information, the effective scene information can be better described through the weighted histogram of the HDR image, and the long and short exposure parameters calculated through the weighted histogram of the HDR image can be more accurate under large scene variations, thereby enhancing the generation quality of HDR images.

It should be understood that although the steps in the flowcharts involved in the above embodiments are sequentially displayed as indicated by the arrows, these steps are not necessarily performed in the order indicated by the arrows. Unless explicitly stated herein, the execution of these steps is not strictly limited, and these steps may be executed in other orders. Moreover, at least a part of the steps in the flowcharts involved in the above embodiments may include multiple sub-steps or multiple stages, these sub-steps or stages are not necessarily performed at the same time, but may be performed at different times, and the execution order of these sub-steps or stages is not necessarily performed sequentially, but may be performed in turn or alternately with other steps or with at least a part of sub-steps or stages in other steps.

Based on the same inventive concept, an embodiment of the present disclosure further provides an image generation apparatus for implementing the foregoing image generation method. The problem-solving implementation solution provided by the apparatus is similar to the implementation solution described in the above method, so the specific limitations in one or more embodiments directed to the image generation apparatus provided below may refer to the limitations in the above image generation method, which will not be repeated here.

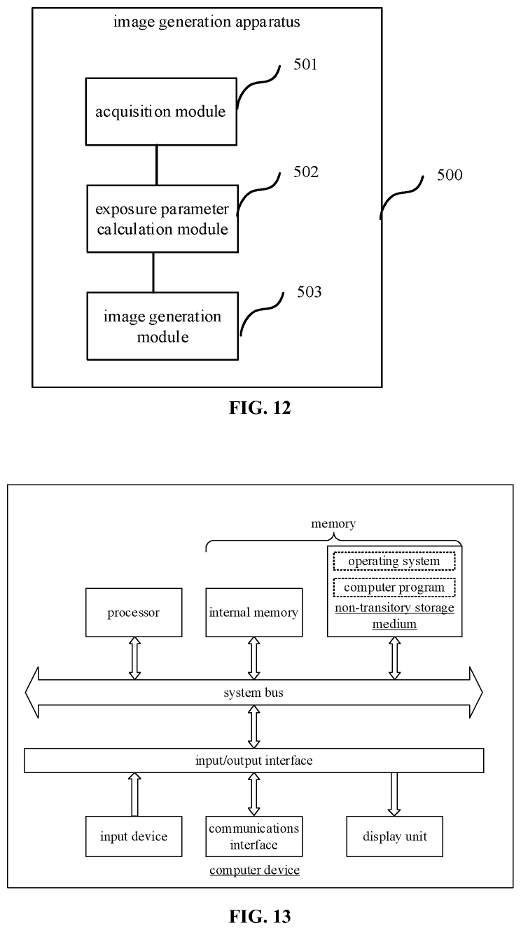

In an exemplary embodiment, as shown in FIG. 12, an image generation apparatus 500 is provided, including an acquisition module 501, an exposure parameter calculation module 502, and an image generation module 503.

The acquisition module 501 is configured to obtain image statistical information of a previous HDR frame.

The exposure parameter calculation module 502 is configured to: generate a weighted histogram of the previous HDR frame based on the image statistical information of the previous HDR frame, the weighted histogram being configured for describing effective scene information of the previous HDR frame; and calculate long and short exposure parameters of a current HDR frame based on the weighted histogram of the previous HDR frame.

The image generation module 503 is configured to obtain the current HDR frame based on the long and short exposure parameters of the current HDR frame.

In an embodiment, the image statistical information includes an exposure parameter and statistical luminance information. The exposure parameter calculation module 502 is further configured to: select a lightest image block in the previous HDR frame as a photometry target and perform photometry measurement on the lightest image block based on the exposure parameter of the previous HDR frame to obtain scene photometric data of the lightest image block; perform weighting processing on the statistical luminance information of a center region of the previous HDR frame based on the scene photometric data of the lightest image block to obtain weighted region luminance of the center region; divide a luminance range of the previous HDR frame into multiple luminance intervals based on the weighted region luminance of the center region; calculate respective weighting parameters for curve segments in a histogram weighting curve that correspond to the multiple luminance intervals; and generate the weighted histogram of the previous HDR frame based on the weighting parameters of the curve segments corresponding to the multiple luminance intervals in the histogram weighting curve.

In an embodiment, the exposure parameter calculation module 502 is further configured to: determine a luminance weight parameter of the center region of the previous HDR frame based on the scene photometric data of the lightest image block; and perform weighting processing on a maximum luminance of the center region, a minimum luminance of the center region, and an average luminance of the center region in the statistical luminance information according to the luminance weight parameter of the center region of the previous HDR frame, to obtain the weighted region luminance of the center region.

In an embodiment, the exposure parameter calculation module 502 is further configured to: determine a illumination-prior center non-saliency probability of the previous HDR frame based on the scene photometric data of the lightest image block; determine a spatial-luminance center distribution probability of the previous HDR frame based on the weighted region luminance of the center region; and determine the weighting parameters of the curve segments corresponding to the multiple luminance intervals in the histogram weighting curve based on the illumination-prior center non-saliency probability and the spatial-luminance center distribution probability.

In an embodiment, the exposure parameter calculation module 502 is further configured to: determine, based on the scene photometric data of the lightest image block, a target scene type corresponding to the previous HDR frame and a condition for filtering block(s) of interest corresponding to the target scene type; determine, based on the condition for filtering block(s) of interest, the quantity of block(s) of interest in a pericentral region in the previous HDR frame; and quantify the quantity of block(s) of interest in the pericentral region in the previous HDR frame into the illumination-prior center non-saliency probability of the previous HDR frame.

In an embodiment, the exposure parameter calculation module 502 is further configured to: determine quantities of light blocks and dark blocks in the pericentral region in the previous HDR frame based on the weighted region luminance of the center region; determine a proportion and a spatial symmetry parameter of the light blocks in the pericentral region and a proportion and a spatial symmetry parameter of the dark blocks in the pericentral center region based on the quantities of the light blocks and the dark blocks in the pericentral region; determine a light center distribution probability and a dark center distribution probability based on the proportions and the spatial symmetry parameters of the light blocks and the dark blocks in the pericentral region; and determine the spatial-luminance center distribution probability of the previous HDR frame based on the light center distribution probability and the dark center distribution probability.

In an embodiment, the exposure parameter calculation module 502 is further configured to: obtain a noise threshold and a saturation threshold of a camera component; determine a ratio of a short exposure gain value to a long exposure gain value of the current HDR frame based on the weighted histogram of the previous HDR frame, the noise threshold, and the saturation threshold; and if the ratio of the short exposure gain value to the long exposure gain value is greater than or equal to the minimum allowable gain ratio of the image sensor, take initial exposure parameters of the current HDR frame corresponding to the weighted histogram of the previous HDR frame as the long and short exposure parameters of the current HDR frame.

In an embodiment, the exposure parameter calculation module 502 is further configured to: if the ratio of the short exposure gain value to the long exposure gain value is less than the minimum allowable gain ratio, solve an exposure optimization equation of the weighted histogram according to an exposure gain constraint to obtain the long and short exposure parameters of the current HDR frame.

The exposure gain constraint is that the ratio of the short exposure gain value to the long exposure gain value is equal to the minimum allowable gain ratio. An optimization objective of the exposure optimization equation is to minimize a proportion of the weighted histogram outside a target region and the target region is a region bounded by the noise threshold and the saturation threshold.

In an embodiment, the image generation module 503 is further configured to: capture a current frame of interleaved exposure LDR image based on the long and short exposure parameters of the current HDR frame; and synthesize the current frame of interleaved exposure LDR image to obtain the current HDR frame.

All or some of the modules in the foregoing image generation apparatus may be implemented by using software, hardware, or a combination thereof. The foregoing modules may be embedded in or independent of a processor in a computer device in a hardware form, or may be stored in a memory in a computer device in a software form, so that the processor invokes and performs operations corresponding to the foregoing modules.

In an exemplary embodiment, a computer device is provided, which may be a terminal, and an internal structure diagram thereof may be as shown in FIG. 13. The computer device includes a processor, a memory, an input/output interface, a communication interface, a display unit, and an input device. The processor, the memory, and the input/output interface are connected via a system bus, and the communication interface, the display unit, and the input device are connected to the system bus via the input/output interface. The processor of the computer device is configured to provide computing and control capabilities. The memory of the computer device includes a non-transitory storage medium and an internal memory. The non-transitory storage medium stores an operating system and a computer program. The internal memory provides an environment for the operation of the operating system and the computer program in the non-transitory storage medium. The input/output interface of the computer device is configured to exchange information between the processor and an external device. The communication interface of the computer device is configured to perform wired or wireless communication with an external terminal, and the wireless communication may be implemented by using WI-FI, a mobile cellular network, near field communication (NFC), or other technologies. The computer program is executed by the processor to implement an image generation method. The display unit of the computer device is configured to form a visually visible image, and may be a display screen, a projection device, or a virtual reality imaging device. The display screen may be a liquid crystal display screen or an electronic ink display screen, and the input device of the computer device may be a touch layer covered on the display screen, or may be a button, a trackball, or a touchpad disposed on a housing of the computer device, or may be an external keyboard, touchpad, or mouse.

A person skilled in the art may understand that the structure shown in FIG. 13 is merely a block diagram of a partial structure related to the solution of the present disclosure, and does not constitute a limitation on a computer device to which the solution of the present disclosure is applied. A specific computer device may include more or fewer components than those shown in FIG. 13, or some components can be combined, or a different component arrangement is present.

In an exemplary embodiment, a computer device is provided, including a memory and a processor. The memory stores a computer program, and the processor, when executing the computer program, performs the foregoing image generation method.

In an embodiment, a non-transitory computer-readable storage medium is provided, storing a computer program thereon. The computer program, when executed by a processor, causes the processor to perform the above image generation method.

In an embodiment, a computer program product is provided, including a computer program. The computer program, when executed by a processor, causes the processor to perform the foregoing image generation method.

It should be noted that user information (including but not limited to user equipment information, user personal information, and the like) and data (including but not limited to data used for analysis, stored data, displayed data, and the like) in the present disclosure are all information and data authorized by users or fully authorized by all parties, and the collection, use, and processing of related data need to comply with the relevant regulations.

A person of ordinary skill in the art may understand that all or some of the processes in the methods of the foregoing embodiments may be implemented by a computer program instructing the relevant hardware, the computer program may be stored in a non-transitory computer-readable storage medium, and when the computer program is executed, the processes of the methods according to the foregoing embodiments may be implemented. Any reference to a memory, a database, or any other medium used in the embodiments provided in the present disclosure may include at least one of a non-transitory memory and a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, or the like. The transitory memory may include a random access memory (RAM), an external cache, or the like. By way of illustration and not limitation, the RAM may be in various forms, such as a static random access memory (SRAM) or a dynamic random access memory (DRAM). The database in the embodiments provided in the present disclosure may include at least one of a relational database or a non-relational database. The non-relational database may include, but is not limited to, a blockchain-based distributed database. The processor in the embodiments provided in the present disclosure may be a general-purpose processor, a central processing unit, a graphics processing unit, a digital signal processor, a programmable logic device, a data processing logic device based on quantum computing, an artificial intelligence (AI) processor, or the like, and is not limited thereto.

The technical features of the above embodiments may be arbitrarily combined, and in order to make the description concise, not all possible combinations of the technical features in the above embodiments are described; however, as long as there is no contradiction between the combinations of these technical features, it should be considered as within the scope of the present disclosure.

The above embodiments only express several implementations of the present application, and the description thereof is specific and detailed, but cannot be construed as limiting the scope of the present application. It should be noted that for those of ordinary skill in the art, several variations and improvements can be made without departing from the concept of the present application, which all fall within the protection scope of the present application. Therefore, the protection scope of the present application shall be subject to the appended claims.

What is claimed is:

1. An image generation method, comprising:
obtaining image statistical information of a previous high-dynamic-range (HDR) frame;
generating a weighted histogram of the previous HDR frame based on the image statistical information of the previous HDR frame, the weighted histogram being configured for describing effective scene information of the previous HDR frame;
calculating long and short exposure parameters of a current HDR frame based on the weighted histogram of the previous HDR frame; and
obtaining the current HDR frame based on the long and short exposure parameters of the current HDR frame.

2. The image generation method according to claim 1, wherein the image statistical information comprises an exposure parameter and statistical luminance information; and the generating the weighted histogram of the previous HDR frame based on the image statistical information of the previous HDR frame comprises:
taking a lightest image block in the previous HDR frame as a photometry target and conducting photometric measurement on the lightest image block based on the exposure parameter of the previous HDR frame, to obtain scene photometric data of the lightest image block;
performing weighting processing on the statistical luminance information of a center region of the previous HDR frame based on the scene photometric data of the lightest image block, to obtain a weighted region luminance of the center region;
dividing a luminance range of the previous HDR frame into a plurality of luminance intervals based on the weighted region luminance of the center region;
calculating respective weighting parameters for curve segments in a histogram weighting curve that correspond to the plurality of luminance intervals; and
generating the weighted histogram of the previous HDR frame based on the weighting parameters of the curve segments corresponding to the plurality of luminance intervals in the histogram weighting curve.

3. The image generation method according to claim 2, wherein the performing weighting processing on the statistical luminance information of the center region of the previous HDR frame based on the scene photometric data of the lightest image block, to obtain the weighted region luminance of the center region comprises:
determining a luminance weight parameter of the center region of the previous HDR frame based on the scene photometric data of the lightest image block; and
weighting a maximum luminance of the center region, a minimum luminance of the center region, and an average luminance of the center region in the statistical luminance information according to the luminance weight parameter of the center region of the previous HDR frame, to obtain the weighted region luminance of the center region.

4. The image generation method according to claim 2, wherein the calculating the respective weighting parameters for the curve segments in the histogram weighting curve that correspond to the plurality of luminance intervals comprises:
determining an illumination-prior center non-saliency probability of the previous HDR frame based on the scene photometric data of the lightest image block;
determining a spatial-luminance center distribution probability of the previous HDR frame based on the weighted region luminance of the center region; and
determining the weighting parameters of the curve segments corresponding to the plurality of luminance intervals in the histogram weighting curve based on the illumination-prior center non-saliency probability and the spatial-luminance center distribution probability.

5. The image generation method according to claim 4, wherein the determining the illumination-prior center non-saliency probability of the previous HDR frame based on the scene photometric data of the lightest image block comprises:
determining, based on the scene photometric data of the lightest image block, a target scene type corresponding to the previous HDR frame and a condition for filtering block(s) of interest corresponding to the target scene type;
determining a quantity of block(s) of interest in a pericentral region in the previous HDR frame based on the condition for filtering block(s) of interest; and
quantifying the quantity of block(s) of interest in the pericentral region in the previous HDR frame into the illumination-prior center non-saliency probability of the previous HDR frame.

6. The image generation method according to claim 4, wherein the determining the spatial-luminance center distribution probability of the previous HDR frame based on the weighted region luminance of the center region comprises:
determining quantities of light blocks and dark blocks in the pericentral region in the previous HDR frame based on the weighted region luminance of the center region;
determining a proportion and a spatial symmetry parameter of the light blocks in the pericentral region and a proportion and a spatial symmetry parameter of the dark blocks in the pericentral region based on the quantities of the light blocks and the dark blocks in the pericentral region;
determining a light center distribution probability and a dark center distribution probability based on the proportions and the spatial symmetry parameters of the light blocks and the dark blocks in the pericentral region; and
determining the spatial-luminance center distribution probability of the previous HDR frame based on the light center distribution probability and the dark center distribution probability.

7. The image generation method according to claim 1, wherein the calculating the long and short exposure parameters of the current HDR frame based on the weighted histogram of the previous HDR frame comprises:
obtaining a noise threshold and a saturation threshold of an image sensor;
determining a ratio of a short exposure gain value to a long exposure gain value of the current HDR frame based on the weighted histogram of the previous HDR frame, the noise threshold, and the saturation threshold; and
if the ratio of the short exposure gain value to the long exposure gain value is greater than or equal to the minimum allowable gain ratio of the image sensor, taking initial exposure parameters of the current HDR frame corresponding to the weighted histogram of the previous HDR frame as the long and short exposure parameters of the current HDR frame.

8. The image generation method according to claim 7, wherein after determining the ratio of the short exposure gain value to the long exposure gain value of the current HDR frame, the image generation method further comprises:
if the ratio of the short exposure gain value to the long exposure gain value is less than the minimum allowable gain ratio of the image sensor, solving an exposure optimization equation of the weighted histogram according to an exposure gain constraint to obtain the long and short exposure parameters of the current HDR frame;
wherein the exposure gain constraint is that the ratio of the short exposure gain value to the long exposure gain value is equal to the minimum allowable gain ratio, and an optimization objective of the exposure optimization equation is to minimize a proportion of the weighted histogram outside a target region, the target region being a region bounded by the noise threshold and the saturation threshold.

9. The image generation method according to claim 1, wherein the obtaining the current HDR frame based on the long and short exposure parameters of the current HDR frame comprises:
capturing a current frame of interleaved exposure low-dynamic-range (LDR) image based on the long and short exposure parameters of the current HDR frame; and
synthesizing the current frame of interleaved-exposure LDR image to obtain the current HDR frame.

10. An image generation apparatus, comprising:
an acquisition module, configured to obtain image statistical information of a previous high-dynamic-range (HDR) frame;
an exposure parameter calculation module, configured to generate a weighted histogram of the previous HDR frame based on the image statistical information of the previous HDR frame, the weighted histogram being configured to describe effective scene information of the previous HDR frame; and calculate long and short exposure parameters of a current HDR frame based on the weighted histogram of the previous HDR frame; and
an image generation module, configured to obtain the current HDR frame based on the long and short exposure parameters of the current HDR frame.

11. A computer device, comprising a memory which stores a computer program therein and a processor, wherein the processor, when executing the computer program, perform the steps of the image generation method according to claim 1.

12. A non-transitory computer-readable storage medium, which stores a computer program thereon, wherein the computer program, when executed by a processor, causes the processor to perform the steps of the image generation method according to claim 1.

13. A computer program product, comprising a computer program, wherein the computer program, when executed by a processor, causes the processor to perform the steps of the image generation method according to claim 1.
